(19) United States
(12) Patent Application Publication
(10) Pub. No.: US 2005/0092479 A1
(43) Pub. Date: May 5, 2005

(54) Air-conditioner for vehicles

(76) Inventors: Tadashi Umeo, Nagoya-city (JP); Yukio Ueno, Toyokawa-city (JP); Shigenori Hirao, Toyohashi-city (JP)

Correspondence Address: HARNESS, DICKEY & PIERCE, P.L.C., P.O. BOX 828, BLOOMFIELD HILLS, MI, 48303, US

(21) Appl. No.: 10/952,567

(22) Filed: Sep. 28, 2004

(30) Foreign Application Priority Data
Oct. 10, 2003 (JP) 2003-352610

(51) Int. Cl. B60H 3/00; B61D 27/00; B60H 1/00; B60H 1/32

(52) U.S. Cl. 165/202; 165/43; 62/244

(57) ABSTRACT

In an air conditioner for vehicles which has an air conditioning unit mounted at a roof portion of the vehicle, an evaporator and a heat exchanger for heating to air-condition a cabin of the vehicle, provided are plural blow-out opening portions which are formed in the air conditioning unit and open air flow passages in accordance with each blow-out mode, plural blow-out ports which are connected to the corresponding blow-out opening portions provided at the ceiling portion of the vehicle so as to intercommunicate with the blow-out opening portions and blow out air-conditioned air adjusted in temperature, foot blow-out ports of the blow-out ports through which hot air is blown out downwardly in the cabin of the vehicle, and an air blowing unit for sucking hot air blown out from the foot blow-out ports and blowing out the hot air thus sucked to the feed of occupants.

### FIELD OF THE INVENTION

The invention relates to an air conditioner for vehicles which is mounted in a vehicle such as a truck or the like, and particularly to an air conditioner having an air conditioning unit mounted on the roof of a vehicle to blow out air-conditioned air from the ceiling portion of the vehicle under heating operation.

### BACKGROUND OF THE INVENTION

There has been hitherto known such an air conditioner that an air conditioning unit for forming air flow passages is mounted at a ceiling portion or a roof portion of a vehicle as described in JP 09-249020A, for example. An air conditioner for vehicles as described above air-conditions the driver's cabin of a compact special kind car such as a construction machine or the like. In the air conditioner thus constructed, plural air blow-out ports and air blow-out ducts which are connected to the blow-out ports and introduce air-conditioned air from the air conditioning unit are provided at the ceiling portion above the head portions of occupants.

In the case of a special kind vehicle, an air blow-out duct having foot defroster blow-out ports through which air is blown downwardly along the inner surface of a front window at the front side of the vehicle is disposed at the forefront portion of the ceiling portion of the cabin of the vehicle. A face blow-out duct having face blow-our ports through which air is blown out to the upper bodies of the occupants in the cabin is joined to the blow-out duct. The air conditioning unit is disposed at the rear side of the blow-out duct in the vehicle cabin. Accordingly, the space for the head portions of the occupants is secured, and also the blow-out ports through which air-conditioned air is blown out are changed between the cooling operation and the heating operation, thereby preventing amenity for the occupants from being damaged.

However, when hot air is blown out to the upper bodies of the occupants to carry out heating operation, the amenity for the occupants is damaged. Therefore, in the conventional air conditioner, the foot-defroster blow-out ports for blowing out hot air are disposed at the forefront portion of the ceiling portion of the cabin of the vehicle and hot air is blown downwardly along the inner surface of the front window at the front side of the vehicle. As compared with the compact special kind vehicle as described above, a truck type vehicle is designed so that the front side of the roof and ceiling portions of the vehicle are streamlined in shape as a whole in order to enhance the traveling performance of the vehicle, and thus it is more difficult to form a space in which the blow-out ports and the air blow-out ducts are disposed at these portions.

Furthermore, the truck type vehicle has not only two blow-out modes of a face mode under cooling operation and a foot defroster mode under heating operation, but also various other blow-out modes such as a defroster mode for defrosting the front window, a side defroster mode for defrosting the right and left windows, a foot mode under heating operation, a nap mode for air-conditioning a napping cabin behind occupants' seats, etc. It is required to dispose the blow-out ports and the air blow-out ducts at the ceiling portion of the vehicle in connection with the above blow-out modes.

### SUMMARY OF THE INVENTION

The present invention has a first object to provide an air conditioner for vehicles in which air streams are formed so that hot air blown out from blow-out ports is prevented from being blown to the upper bodies of occupants and thus amenity under heating operation is not damaged.

Furthermore, the invention has a second object to provide an air conditioner for vehicles which can secure a head portion space by constructing an air conditioning unit so that no blow-out duct is disposed at the ceiling portion of the vehicle.

The invention has an air blowing unit which can suck hot air blown out from the air conditioning unit provided at the ceiling portion of the vehicle to the lower side of the cabin of the vehicle and blow out the hot air thus sucked to the feet of occupants. Accordingly, the blow-out of the hot air to the upper bodies of the occupants can be suppressed at maximum, and also amenity under heating operation can be prevented from being damaged because the hot air is blown to the feet of the occupants. Furthermore, blow-out ports for heating may be provided between the front window at the front side of the vehicle and the occupants without providing the blow-out ports at the front side of the vehicle, and thus it is easy to mount the blow-out ports for heating.

### BRIEF DESCRIPTION OF THE DRAWINGS

FIG. 1 is a schematic diagram showing an air conditioner for vehicles according to a first embodiment of the invention;

FIG. 2 is a schematic diagram showing an air conditioning unit mounted at a vehicle roof portion shown in FIG. 1;

FIG. 3 is a schematic diagram showing air flow passages of blow-out opening portions and blow-out ports of the air conditioning unit shown in FIG. 1;

FIG. 4 is a schematic diagram showing a refrigerating cycle apparatus of the first embodiment of the invention;

FIG. 5 is a schematic diagram showing an air conditioner for vehicles according to a second embodiment of the invention; and

FIG. 6 is a schematic diagram showing a refrigerating cycle apparatus according to a third embodiment of the invention.

### DETAILED DESCRIPTION OF THE PREFERRED EMBODIMENTS

### First Embodiment

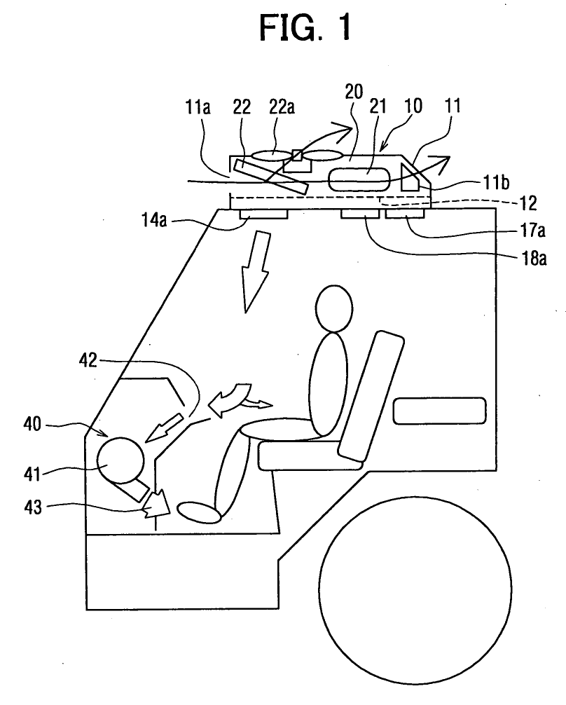

As shown in FIGS. 1 to 3, an air conditioner for vehicles according to this embodiment comprises an air conditioning unit 10 mounted at the roof portion of a vehicle, plural blow-out ports 13a to 17a disposed at the ceiling portion of the vehicle, a suction port 18a for sucking air in the cabin of the vehicle and an air blowing unit 40 disposed in a dashboard of the vehicle. The air conditioning unit 10 is an unit for sucking air in the cabin of the vehicle from an air suction port 18a and blowing out air-conditioned air adjusted in temperature to plural blow-out ports 13a to 17a, and the inside of an air conditioning case 11 thereof is partitioned into upper and lower stages by a partitioning member 12. At the upper stage, a refrigerating cycle apparatus 20 containing a compressor 21, a condenser 22, etc. is integrally disposed, and plural blow-out opening portions 13 to 17 for opening air flow passages in accordance each blow-out mode are formed. At the lower stage are formed the air flow passages intercommunicating from the blow-out opening portions 13 to 17 to the corresponding blow-out ports 13a to 17a.

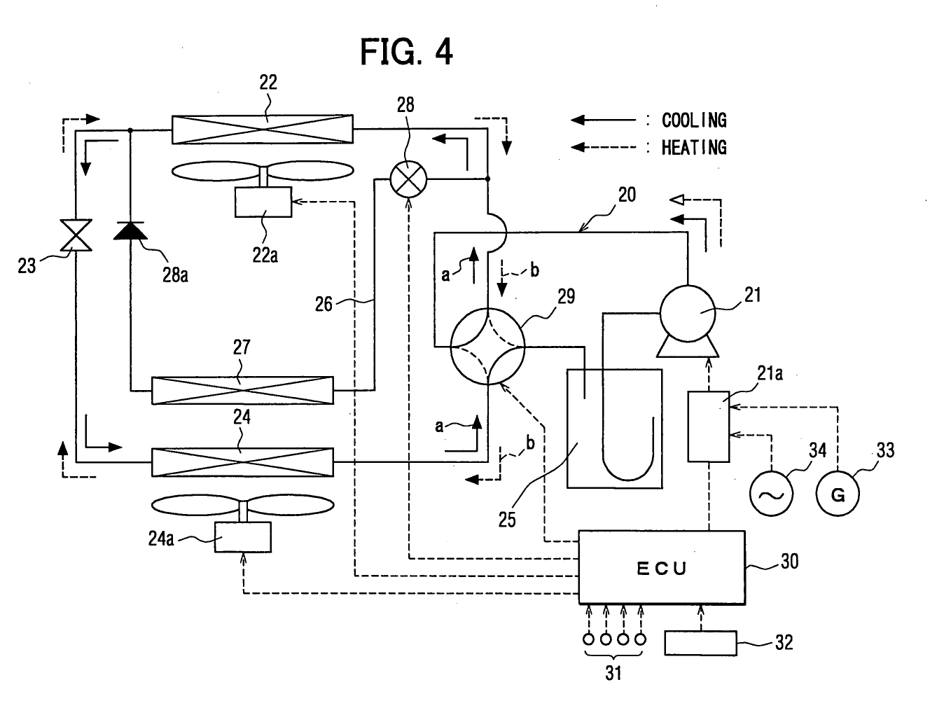

As shown in FIG. 4, the refrigerating cycle apparatus 20 is a heat pump cycle in which the refrigerant flow direction is switched between cooling operation and heating operation, and it is achieved by equipping a four-way valve 29 and an accumulator 25 to a cooling refrigerating cycle comprising the compressor 21, the condenser 22, a pressure-reducing device 23 and an evaporator 24 which are annularly arranged. The four-way valve 29 is switched so that high-pressure refrigerant compressed by the compressor 21 is made to flow to the condenser 22 side under cooling operation or to the evaporator 24 side under heating operation, and low-pressure refrigerant evaporated by the evaporator 24 under cooling operation or by the condenser 22 under heating operation is made to flow to the suction side of the compressor 21.

Furthermore, the accumulator 25 is a container for sucking the low-pressure refrigerant evaporated by the evaporator 24 under cooling operation or by the condenser 22 under heating operation so that gas-liquid separated gas refrigerant is sucked into the compressor 21, and it is provided between the four-way valve 29 and the suction side of the compressor 21. Accordingly, the refrigerant is circulated in a direction of an arrow a indicated by a solid line under cooling operation, and it is circulated in a direction of an arrow b indicted by a broken line under heating operation.

The compressor 21 is a motor-driven compressor having an electric motor. It is electrically connected through an inverter 21a to an external commercial power source 34 and a battery 33 which is charged through driving of a vehicle engine or a source of power for the vehicle such as an electric motor or the like, and driven by any one of the external commercial power source 34 and the battery 33. When the truck type vehicle travels, power is supplied to the inverter 21a from the battery 33 charged through the driving of the vehicle power source to drive the compressor 21. When the vehicle is stopped and thus the vehicle power source is stopped, power is supplied from any one of the charged battery 33 and the external commercial power source 34 to the inverter 21a to drive the compressor 21.

The inverter 21a controls the frequency of the power to be output to the electric motor contained in the compressor 21, and it is electrically connected to and controlled by a controller 30. When the inverter 21a from the external commercial power source 34, power is supplied from a power source origin (not shown) through a power strip (not shown) to the external commercial power source 34.

The condenser 22 condenses high-temperature and high-pressure refrigerant gas compressed by the compressor 21 under cooling operation. It is combined with a condensing fan 22a and takes air at the outside of the air conditioning unit 10 to heat-exchange the intake air with refrigerant to condense the refrigerant. The pressure-reducing device 23 reduces the pressure of the condensed refrigerant to expand the condensed refrigerant, and it is formed of a capillary tube or the like. The refrigerant whose pressure is reduced by the pressure-reducing device 23 flows into the evaporator 24.

The evaporator 24 is a heat exchanger for evaporating the pressure-reduced refrigerant. It is combined with an air blower 24a, and the evaporator 24 and the air blower 24a intercommunicate with the cabin of the vehicle. By actuating the air blower 24a, air in the vehicle cabin is taken and heat-exchanged with the refrigerant in the evaporator 24, so that air-conditioned air is blown out from any of plural blow-out ports 13a to 17a into the vehicle cabin. The refrigerant evaporated by the evaporator 24 flows to the suction side of the compressor 21.

The refrigerating cycle apparatus 20 is equipped with a bypass circuit 26 through which a part of the high-pressure refrigerant compressed by the compressor 21 bypasses the condenser 22 under cooling operation, and the bypass circuit 26 is equipped with a heat exchanger 27 for heating, an electromagnetic valve 28 and a check valve 28a. The heat exchanger 27 for heating heat-exchanges the high-pressure refrigerant with air cooled by the evaporator 24 to heat the air.

Furthermore, the electromagnetic valve 28 is a control valve for opening/closing the flow of the high-pressure refrigerant to the heat exchanger 27 for heating, and electrically connected to and controlled by the controller 30. The electromagnetic valve 28 is controlled to be opened under cooling operation. The check valve 28a is a valve for preventing the refrigerant condensed by the condenser 22 from flowing to the heat exchanger 27 side. The electrical devices such as the four-way valve 29, the condensing fan 22a, the air blower 24a and the electromagnetic valve 28 as well as the inverter 21a are electrically connected to and controlled by the controller 30.

The controller 30 comprises a computer, and carries out predetermined operation processing according to a preset program on the basis of detection signals from various kinds of sensors 31 such as an inside air temperature sensor, an outside air temperature sensor, a solar isolation sensor, etc. and operating signals from an operating panel 32 to control the above electrical devices. The inverter 21a, the battery 33, the external commercial power source 34 and the controller 30 are accommodated in the conditioning unit 10 as in the case of the refrigerating cycle apparatus 20.

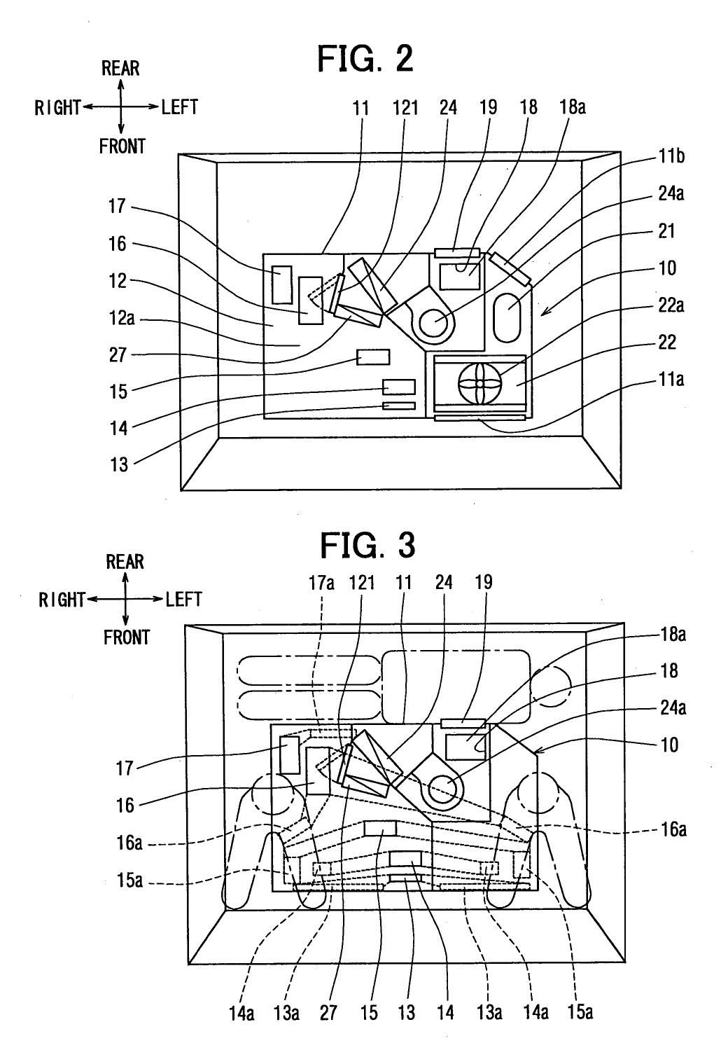

Specifically, as shown in FIGS. 1 and 2, the compressor 21 is disposed at the vehicle left side of the air conditioning case 11, and the condensing fan 22a and the condenser 22 are disposed at the vehicle front side. Air taken from the front-side opening portion 11a formed in the air conditioning case 11 passes through the condenser 22, and the air passing through the condenser 22 is discharged to the. outside by the condensing fan 22a. A part of the air passing through the condenser 22 passes through the compressor 21 and then is discharged from a grille 11b formed in the air conditioning case 11.

Accordingly, the electric motor at the compressor 21 side can be cooled by the part of the air passing through the condenser 22. When the vehicle travels, traveling wind is taken from the front-side opening portion 11a. The four-way valve 29, the electromagnetic valve 28 and the accumulator 25 are disposed in the neighborhood of the compressor 21 as not shown. Accordingly, a refrigerant pipe for connecting the refrigerant cycle parts to one another is simplified.

The air blower 24a and the evaporator 24 are disposed adjacently to the compressor 21 at the site sectioned at the vehicle right side. A suction opening portion 18 intercommunicating with the vehicle cabin is formed at the upstream side of the air flow of the air blower 24a by the partitioning member 12. The air flow passage is formed so that the upstream end is connected to the suction port 18a provided in the vehicle ceiling portion. Accordingly, the air in the vehicle cabin which is sucked from the suction port 18a by the air blower 24a is blown out to the evaporator 24. The pressure-reducing device 23 is provided at the flow-in side of the evaporator 24 and disposed in the neighborhood of the evaporator 24.

An outside air introducing port 19 is formed at the air conditioning case 11 side behind the suction opening port 18. An inside/outside air switching door (not shown) is provided between the outside air introducing port 19 and the suction opening portion 18, and the inside/outside air to be sucked to the air blower 24a is switched by controlling the inside/outside air switching door.

An air mixing door 121 and the heat exchanger 27 for heating are disposed at the downstream side of the evaporator 24 in the air flow direction, and an air mixing portion 12a is formed at the downstream side thereof. The air mixing door 121 is a control door for adjusting the mixture ratio of the air bypassing the heat exchanger 27 for heating and the air passing through the heat exchanger 27 for heating to adjust the temperature. The air mixing portion 12a is an air chamber in which cold air flowing from the air mixing door 121 and hot air passing through the heat exchanger 27 for heating are mixed with each other, and the plural blow-out opening portions 13 to 17 are formed in the partitioning member 12.

The plural blow-out opening portions 13 to 17 are formed so as to intercommunicate with the corresponding blow-out ports 13a to 17a. Specifically, for example, a defroster opening portion 13, a foot opening portion 14, a side defroster opening portion 15, a face opening portion 16 and a nap opening portion 17 are formed in this order from the vehicle front side to the vehicle rear side. The defroster opening portion 13, the foot opening portion 14 and the side defroster opening portion 15 of these blow-out opening portions 13 to 17 are formed substantially at the center side in the right and left direction of the vehicle, and the face opening portion 16 and the nap opening portion 17 are formed at the right-handed driver's seat side of the vehicle.

This is because the air flow passages are formed at the lower stage of the air conditioning case 11 so as to intercommunicate with the plural blow-out ports 13a to 17a provided at the ceiling portion of the vehicle as shown in FIG. 3. The defroster opening portion 13 forms the air flow passage so as to intercommunicate with the defroster blow-out port 13a for blowing out hot air downwardly along the inner surface of the front window of the of the vehicle.

The foot opening portion 14 forms the air flow passage between the occupant and the front window of the vehicle so as to intercommunicate with the foot blow-out port 14a for blowing out hot air downwardly. The side defroster opening portion 15 forms the air flow passage so as to intercommunicate with the side defroster blow-out ports 15a for blowing out hot air downwardly along the inner surface of the side windows of the vehicle. The face opening portion 16 forms the air flow passage so as to intercommunicate with the face blow-out ports 16a for blowing out cool air to the upper bodies of the occupants. The nap opening portion 17 forms the air flow passage so as to intercommunicate with the nap blow-out port 17a for blowing out air-conditioned air to the napping cabin provided behind the occupants' seats.

One-dotted chain lines of FIG. 3 represent an occupant sitting on the driver's seat, an occupant sitting on the assistant driver's seat and an occupant lying in the napping cabin. These plural blow-out ports 13a to 17a are equipped at the ceiling portion of the vehicle on the basis of the positional relationship with the driver's seat, the assistance driver's seat and the napping cabin, and also every right and left two blow-out ports 13a to 17a excluding the napping blow-out port 17a are provided for the driver's seat and the assistant driver's seat so as to confront each other. The foot blow-out ports 14a and the side defroster blow-out ports 15a are heating blow-out ports for blowing out hot air. On the other hand, the suction port 18a is located at the oblique right rear side of the assistant driver's seat, and this position is coincident with the position substantially beneath the suction opening portion 18 formed in the air conditioning case 11.

A control door (not shown) is provided at the upstream side of the air flow of each of the plural blow-out opening portions 13 to 17 formed in the partition member 12, and also an actuator for driving each control door (not shown)is provided. Each actuator is controlled by the controller 30 so that the control door is opened in accordance with each blow-out mode. The blow-out mode contains the operating modes such as the defroster mode, the cooling mode, the heating mode, the dehumidifying and heating mode, the napping cabin mode, etc., and any of the blow-out opening portions 13 to 17 is opened in accordance with each blow-out mode.

In the case of the defroster mode, the defroster opening portion 13 is opened, and in the case of the cooling mode, the face opening portion 16 is opened. Furthermore, in the case of the heating mode, the foot opening portion 14 is opened. In the case of the dehumidifying and heating mode, the defroster opening portion 13 and the side defroster opening portion 15 are opened, and in the case of the napping cabin mode, the nap opening portion 17 is opened. In the case of the heating mode, the defroster opening portion 13 and the side defroster opening portion 15 may be partially opened in addition to the foot opening portion 14 to defog the windows of the vehicle.

Furthermore, in the above construction, the electrical devices such as the inverter 21a, the battery 33, the external commercial power source 34, the controller 30, etc. are accommodated in a space (not shown) of the air mixing portion 12a, for example, at positions at which the air flow is not effected. The battery 33 may be disposed in the engine room of the vehicle rather than in the air conditioning unit 11. In this case, a power cord having a large diameter for connecting an electric generator at the vehicle side and the battery 33 can be designed to be shorter in length, and thus the cost of parts can be reduced.

In this embodiment, when the blow-out mode is the heating mode, the air-conditioned air blown out from the foot blow-out ports 14a is hot air. Accordingly, each foot blow-out port 14a is provided at the position where hot air is downwardly blown out between each occupant and the front window of the vehicle, and the air blowing unit 40 for sucking the hot air blown out from the foot blow-out ports 14a and then blowing out the hot air thus sucked to the foot portions of the occupants is disposed in the dashboard.

As shown in FIG. 1, the air blowing unit 40 comprises an air blower 41, a suction port 42 and a blow-out port 43, and they are integrally constructed in the dashboard. The suction port 42 at the upper end is provided within a blow-out range of air-conditioned air blown out from the foot blow-out port 14a,. and the blow-out port 43 at the lower end is formed so as to blow out the air to the foot portion of each occupant. The air blower 41 is electrically connected to the controller 30 so that it is interlockingly controlled in the blow-out mode in which the foot opening portion 14 is opened.

Next, the operation of the air conditioner for vehicles will be described. In the case of the blow-out mode in which the cabin of the vehicle is cooled while the truck travels (the source of power for vehicle is actuated), when the cooling mode and an air-conditioning switch are operated by a blow-out mode switch (not shown)in the operating panel 32, the four-wave valve 29 is switched to cooling operation (solid line in FIG. 4) by the controller 30, and the inverter 21a is controlled to be supplied with power from the battery 33 charged through the driving of the source of power for the vehicle, thereby driving the compressor 21.

The refrigerant in the refrigerating cycle apparatus 20 is circulated through the driving of the compressor 21. Through the driving of the air blower 24a, air in the cabin of the vehicle is taken into the evaporator 24 and cooled by the evaporator 24. The air-conditioned air thus cooled is blown out through the face opening portion 16 from the face blow-out ports 16a to the upper bodies of the occupants, whereby normal cooling can be carried out on the cabin of the truck type vehicle.

Furthermore, when it is required to cool the cabin of the truck type vehicle while the source of power for the vehicle is stopped and the vehicle is stopped for a long time because of delivery of baggage, the blow-out mode switch and the air-conditioning switch (not shown) are operated, the inverter 21a is controlled by the controller 30 so as to be supplied with power from the battery 33 charged through the driving of the vehicle engine, whereby the compressor 21 is driven. Accordingly, even when the vehicle engine is stopped, the refrigerant in the refrigerating cycle apparatus 20 is circulated by the driving of the compressor 21 and thus the cooling operation of the cabin of the truck type vehicle is continued by the actuation of the air blower 24a like the case where the vehicle is traveling as described above. In this case, however, the air-conditioning operation can be carried out for only the time corresponding to the charge amount stored in the battery 33.

In a case where the inverter 21a is supplied with power from the external commercial power source 34 by using a power cord (not show) when the source of power for the vehicle is stopped, upon receiving a signal of power supply from the external commercial power source 34, the inverter 21a is controlled by the controller 30 so as to be supplied with power from the external commercial power source 34, so that the compressor 21 is driven and the cooling operation of the cabin of the vehicle is carried out.

Furthermore, when the source of power for the vehicle is stopped because the occupant on the driver's seat wants to have a nap in the napping cabin as in the case of the delivery of baggage, the nap mode and the air-conditioning switch are operated by the blow-out mode switch (not shown), the compressor 21 is driven by the controller 30, and also the napping opening portion 17 is opened to blow out cool air from the napping blow-out port 17a to the napping cabin, whereby the napping cabin can be cooled.

When a blow-out mode in which the outside air temperature is relatively low and the humidity is high corresponds to the dehumidifying and heating mode, upon operating the dehumidifying and heating mode and the air-conditioning switch by the blow-out mode switch (not shown), the electromagnetic valve 28 is opened by the controller 30, so that a part of high-temperature and high-pressure refrigerant is circulated into the heat exchanger 27 for heating. In addition, the defroster opening portion 13 and the side defroster opening portion 15 are opened, so that dehumidified air-conditioned air is blown out from the defroster blow-out ports 13a and the side defroster blow-out ports 15a to defog the windows of the truck type vehicle.

In the heating mode, upon operating the heating mode and the air-conditioning switch by the blow-out mode switch (not shown), the four-way valve 29 is switched to the heating operation (indicated by a broken line of FIG. 4) by the controller 30 and the compressor 21 is driven, so that high-pressure gas flows from the compressor 21 to the evaporator 24 side. Furthermore, the foot opening portion 14 is opened, and hot air is blown out from the foot blow-out ports 14a by the air blower 24a. In addition, the air blower 41 of the air blowing unit 40 is actuated to suck the hot air blown out from the foot blow-out ports 14a and then blow out the hot air thus sucked to the foot portions of the occupants. Accordingly, the hot air which is blow out above the head portions of the occupants can be led to the foot portions of the occupants.

According to the air conditioner for vehicles according to the first embodiment, the refrigerating cycle apparatus 20 can be actuated by any one of the charged battery 33 and the external commercial power source 34 to air-condition the cabin of the vehicle by using the compressor 21 having the electric motor driven by any one of the battery 33 and the external commercial power source 34 even when the source of power for the vehicle is stopped according to regulation of idling.

The conditioning unit 10 is designed so that the refrigerant circuit device 20 containing the compressor 21 is integrally accommodated therein, and mounted at the roof portion of the vehicle. There is not required any pipe member constituting the refrigerating cycle apparatus 20 equipped between the engine room side and the air-conditioning unit 10, so that the air-conditioning unit 10 can be easily mounted in the vehicle and also the number of parts of the air conditioner can be reduced.

The air-conditioning unit 10 is mounted at the roof portion of the vehicle, the plural blow-out ports 13a to 17a are provided at the ceiling portion of the vehicle and the air blowing unit 40 is provided in the dashboard of the vehicle. Therefore, since hot air is blown out from above the head portion of each occupant when the blow-out mode is set to the heating mode, the hot air from the foot blow-out ports 14a is sucked and blown out to the foot portions of the occupants, thereby reducing hot air flowing to the upper bodies of the occupants at maximum. In addition, the hot air is blown out to the foot side, so that amenity under heating operation is not damaged. The foot blow-out port 14a may be provided between the front window of the vehicle and each occupant without providing the foot blow-out port 14a at the front side of the vehicle unlike the prior art, so that it is not difficult to mount the foot blow-out ports 14a.

The suction port 42 of the air blowing unit 40 is disposed within the blow-out range of the hot air blown out from the foot blow-out ports 14a, so that the hot air from the foot blow-out ports 14a is sucked and blown out to the foot side and thus amenity under heating operation is not damaged. Furthermore, the air blowing unit 40 is disposed in the dashboard at the front side of the vehicle, and thus the air blowing unit 40 is integrally constructed in the dashboard, so that the interior of the vehicle side is not damaged and also the air blowing unit 40 can be accommodated in low cost.

Furthermore, the refrigerating cycle apparatus 20 is a heat pump cycle in which the refrigerant flow direction is varied between the cooling operation and the heating operation. Under heating operation, high-temperature and high-pressure refrigerant compressed by the motor-driven compressor 21 flows into the evaporator 24. Therefore, a conventional air conditioner in which heating operation and cooling operation are carried out by combining an evaporator 24 and a heater core using cooling water of a vehicle engine as a heat source needs a pipe member which is provided so as to extend to the roof portion of the vehicle so that the cooling water is made to flow into the heater core, however, the air conditioner of the invention does not need any pipe member by constructing the refrigerating cycle apparatus 20 as the heat pump cycle, and thus the air conditioning unit 10 can be more easily mounted in the vehicle and the number of parts of the air conditioner can be further reduced.

Still furthermore, the refrigerating cycle apparatus 20 is constructed so that a part of high-temperature and high-pressure refrigerant compressed by the compressor 21 flows into the heat exchanger 27 for heating. Therefore, in an air conditioner for vehicles to which dehumidifying and heating operation is needed in such a case that the outside air temperature is relatively low and the windows of the vehicle are fogged, the function thereof can be easily enhanced by actively using a part of the refrigerant in the refrigerating cycle apparatus 20 for heating.

In the air conditioning unit 10, the partitioning member 12 for partitioning the air conditioning unit 10 into the upper stage and the lower stage is formed, and the refrigerating cycle apparatus is disposed at the upper stage. In addition, the plural blow-out opening portions 13 to 17 are formed in the partition member 12, and the air flow passages through which the blow-out opening portions 13 to 17 intercommunicate with the corresponding blow-out ports 13a to 17a are formed at the lower stage. Accordingly, the blow-out ducts through which the blow-out ports 13a to 17a are connected to the blow-out opening portions 13 to 17 can be formed in the air conditioning unit 10, so that no blow-out duct is required to be disposed at the ceiling portion of the vehicle and thus the head space between the head of each occupant and the ceiling portion can be secured.

Furthermore, there are provided the defroster blow-out ports 13a for blowing out hot air downwardly along the inner surface of the front window of the vehicle, the side defroster blow-out ports 15a for blowing out hot air downwardly along the inner surfaces of the side windows of the vehicle, the face blow-out ports 16a for blowing cool air to the upper bodies of the occupants, the foot blow-out ports 14a for blowing out hot air downwardly between the occupants and the front window of the vehicle and the napping blow-out port 17a for blowing out air-conditioned air to the napping cabin provided behind the occupants' seats, and the air conditioner is controlled so that some blow-out ports are selected from the plural blow-out ports 13a to 17a in accordance with each blow-out mode. In the case of a truck type vehicle, a napping cabin is generally provided behind occupants' seats to relieve driving fatigue. Therefore, by blowing out air-conditioned air to the napping cabin, the napping cabin can be air-conditioned even when the source of power for the vehicle is stopped at the stop time of the vehicle. Furthermore, by providing various blow-out ports 13a to 17a, a comfortable air-conditioning operation can be performed in conformity with each blow-out mode.

### Second Embodiment

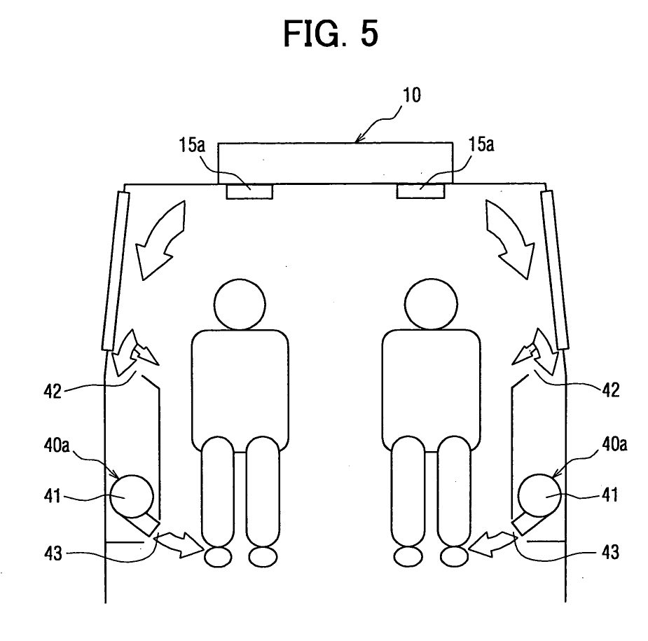

In the first embodiment, the air blowing unit 40 is disposed in the dashboard at the front side of the vehicle. However, it may be disposed in a door trim of the vehicle. Specifically, as shown in FIG. 5, air blowing units 40a are disposed in the right and left door trims of the vehicle. The suction port 42 at the upper end is provided within the blow-out range of the air-conditioned air blown out from the side defroster blow-out port 15a, and the blow-out port 43 at the lower end is designed to blow out air to the foot of an occupant. The air blower 41 is electrically connected to the controller 30 so that in the case of the blow-out mode in which the side defroster opening portion 15 is opened, the air blower 41 is controlled interlockingly.

Accordingly, as in the case of the first embodiment, hot air from the side defroster blow-out ports 15a is sucked and then blown out to the foot side, so that amenity under heating operation is not damaged. Furthermore, the air blowing units 40a are disposed in the door trims of the vehicle, and thus the air blowing units 40a are integrally constructed in the door trims, so that the interior of the vehicle side is not damaged, and also the air blowing units 40a can be accommodated in low cost.

### Third Embodiment

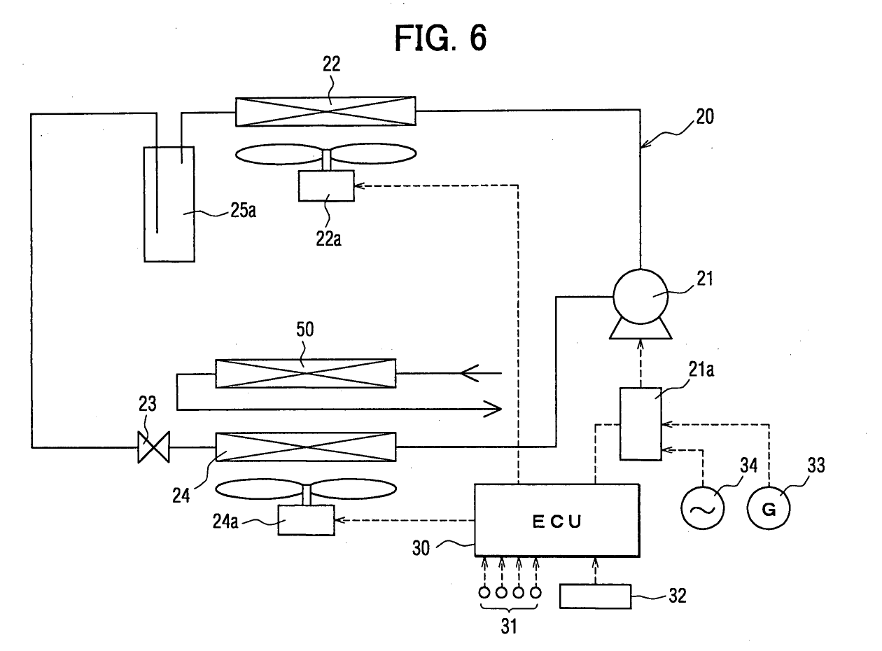

In the above embodiments, the refrigerating cycle apparatus 20 accommodated in the air conditioning unit 10 is constructed as the heat pump cycle in which the refrigerant flow direction is switched between the cooling operation and the heating operation. However, as shown in FIG. 6, it may be an apparatus for carrying out cooling operation and heating operation by combining a refrigerating cycle apparatus 20 for carrying out only the cooling operation with a heater core 50 serving as a heat exchanger for heating which uses cooling water of an engine of a vehicle as a heat source and is located at the downstream side of the evaporator 24 in the air flow direction.

In this case, a receiver 25a is provided between the condenser 22 and the pressure reducing device 23, and an expansion valve is provided to the pressure reducing device 23. Accordingly, there is no problem in heating operation when the vehicle travels. When the engine of the vehicle serving as the source of power for the vehicle is stopped, the cabin of the vehicle can be heated for a while after the vehicle engine is stopped although it is difficult to heat the cabin for a long time.

### Other Embodiments

In the above embodiments, the refrigerating cycle apparatus 20 is integrally disposed in the air conditioning unit 10, however, the invention is not limited to this embodiments. The compressor 21, the condenser 22 and the condensing fan 22a of the refrigerating cycle apparatus 20 may be disposed in the engine room of the vehicle. Furthermore, in the above embodiments, the compressor 21 is constructed by the inverter 21a and the motor-driven compressor driven with power supplied to the inverter 21a, however, it may be a compressor 21 driven by the engine for the vehicle. In this case, when the engine for the vehicle is stopped, it is impossible to air-condition the cabin of the vehicle.

Furthermore, in the above embodiments, the space of a rear portion of a vehicle cabin is cooled or heated while the engine of the vehicle is stopped at the parking time for an outdoor camp or the like in not only a truck type vehicle, but also a one-box type vehicle.

1. An air conditioner for vehicles comprising:
an air conditioning unit mounted at a roof portion of a vehicle and forming air flow passages; and
an evaporator for cooling air and a heat exchanger for heating which heats air passing through the evaporator to air-condition a cabin of the vehicle, the evaporator and the heat exchanger being disposed in the air conditioning unit, characterized by further comprising:
plural blow-out opening portions which are formed in the air conditioning unit and open the air flow passages in accordance with each blow-out mode;
plural blow-out ports which are formed in a ceiling portion of the vehicle and connected to the blow-out opening portions so as to intercommunicate with the blow-out opening portions, and blow out air-conditioned air adjusted in temperature by the air conditioning unit into the cabin of the vehicle;
heating blow-out ports of the plural blow-out ports from which hot air to heat the cabin of the vehicle is downwardly blown out to the cabin of the vehicle; and
an air blowing unit for sucking the hot air blown out from the heating blow-out ports and blowing out the hot air thus sucked to the feet of an occupant.

2. The air conditioner for vehicles according to claim 1, wherein the heating blow-out ports are provided so as to blow out hot air downwardly between the occupant and a front window of the vehicle, the air blowing unit has a suction port at the upper end thereof, and the suction port is disposed within a blow-out range of hot air blown out from the heating blow-out ports.

3. The air conditioner for vehicles according to claim 2, wherein the air blowing unit is disposed in a dashboard at the front side of the vehicle.

4. The air conditioner for vehicles according to claim 1, wherein the heating blow-out ports are provided so as to blow out hot air downwardly along the inner surface of a front window of the vehicle, the air blowing unit has a suction port at the upper end thereof, and the suction port is disposed within a blow-out range of hot air blown out from the heating blow-out ports.

5. The air conditioner for vehicles according to claim 4, wherein the air blowing unit is disposed in a door trim of the vehicle.

6. The air conditioner for vehicles according to claim 1, wherein a refrigerating cycle apparatus including a motor-driven compressor driven by any one of battery means for storing electricity generated through driving of a source of power for the vehicle and an external commercial power source, a condenser and a pressure reducing device in addition to the evaporator is integrally constructed in the air conditioning unit.

7. The air conditioner for vehicles according to claim 6, wherein the refrigerating cycle apparatus is designed as a heat pump cycle in which a refrigerant flowing direction is switched between cooling operation and heating operation, and high-temperature and high-pressure refrigerant compressed by the motor-driven compressor flows into the evaporator under heating operation.

8. The air conditioner for vehicles according to claim 6, wherein the refrigerating cycle apparatus is designed so that a part of the high-temperature and high-pressure refrigerant compressed by the compressor flows into the heat exchanger for heating.

9. The air conditioner for vehicles according to claim 6, wherein a partitioning member is formed to partition the air conditioning unit into an upper stage and a lower stage, the refrigerating cycle apparatus is disposed at the upper stage, the plural blow-out opening portions are formed in the partitioning member, and air flow passages through which the blow-out opening portions and the blow-out ports intercommunicate with one another are formed at the lower stage.

10. The air conditioner for vehicles according to claim 1, wherein the vehicle is a truck type vehicle, the plural blow-out ports contain defroster blow-out ports for blowing hot air downwardly along the inner surface of a front window of the vehicle, side defroster blow-out ports for blowing out hot air downwardly along the inner surfaces of side windows of the vehicle, face blow-out ports for blowing cool air to the upper bodies of occupants, foot blow-out ports for blowing out hot air downwardly between the occupants and the front window of the vehicle, and a napping blow-out port for blowing out air-conditioned air to a napping cabin provided behind occupants' seats, and the air conditioning unit is controlled so that any of the plural blow-out ports is selected in accordance with each blow-out mode.
